(19) United States
(12) Patent Application Publication
(10) Pub. No.: US 2005/0050266 A1
(43) Pub. Date: Mar. 3, 2005

(54) Method and system of storing data in independent memories

(76) Inventors: William Robert Haas, Fort Collins, CO (US); Kirk Steven Tecu, Greeley, CO (US); Dave Boll, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/650,611

(22) Filed: Aug. 27, 2003

(51) Int. Cl. G06F 12/16

(52) U.S. Cl. 711/112; 711/162

(57) ABSTRACT

Application data is stored in a redundant array of independent memories. In one embodiment, the application data is entered in a first memory. The first memory is parked when the first memory has received the application data. The second memory is unparked and application data is entered in the second memory. The second memory is also parked when the second memory has received the application data, thereby reducing the likelihood of losing application data due to physical impacts to the memories.

### BACKGROUND

Portable electronic devices manufactured for capturing, creating, storing, manipulating or transferring digital music, sound, images, movies or other encoded data have become more prevalent with the advent of less expensive semiconductor processing and increased consumer demand. Consumer products such as portable MP3 (Moving Picture Experts Group Layer 3 Standard) players, digital cameras, PDAs (Electronic Personal Data Assistants) and digital voice recorders continue to gain popularity. The general trend for each of these commercial devices is to provide for greater data storage capability at reduced cost.

Unfortunately, greater memory in these devices is accompanied by an increase in cost and time wasted when such large amounts of data are lost. Many portable electronic devices have built-in memory with no redundancy so data cannot be recovered if a memory failure occurs. Even for devices that have the ability to provide back-up data, the time and sophistication required to restore previously backed-up data may be burdensome for the average consumer. Manufacturers are also faced with a more extensive design process, since the use of a PC (personal computer) to provide redundant data and backup also necessitates the design for and use of Microsoft Windows®, MAC®, or other operating system software to provide compatibility between the portable electronic devices and the PC. Also, should purchasers desire to upgrade memory devices in their products, a time consuming process ensues with the purchaser often using a PC to back up data for restoration onto the replacement memory.

Some manufacturers have attempted to solve these problems through increased data throughput to PCs for backup and file transfer. Unfortunately, the single internal or removable memories in these devices often fail prior to back-up, due to physical shock such as dropping, or normal wear and tear. A need exists for a portable electronic device system that provides for data redundancy and easy memory upgrades without the use of a PC.

### SUMMARY

A method is disclosed for storing application data in a redundant array of independent memories. In one embodiment, the method comprises entering the application data in a first memory, parking the first memory when the first memory has received the application data, unparking a second memory, entering the application data in the second memory, and parking the second memory when the second memory has received the application data, thereby reducing the likelihood of losing application data due to physical impacts to the memories.

In another embodiment, a master-slave data management system is disclosed that has a processor, a bus in communication with the processor and first and second data paths removed from the bus. The first and second data paths provide the processor with communication with first and second memories, respectively. The processor is programmed to avoid writing application data to the first memory unless the second memory is parked and the first memory is unparked.

### BRIEF DESCRIPTION OF THE DRAWINGS

The components in the figures are not necessarily to scale, emphasis instead being placed upon illustrating the principals of exemplary embodiments of the invention. Moreover, in the figures, like reference numerals designate corresponding parts throughout the different views.

FIG. 1 is a block diagram of a system of redundant memories in direct connection with a processor in accordance with one embodiment of the invention.

FIG. 2 is a plan view of a hard disk drive having a mechanism for parking an actuator motor arm during non-use.

FIG. 3 is a flow diagram of a method for writing to a plurality of memories that is applicable to the system of FIG. 1.

FIG. 4 is an exploded perspective view illustrating a redundant memory system capable of using the method of FIG. 3.

FIGS. 5 and 6 are exploded perspective views illustrating different modular redundant memory systems that employ a memory storage module and are capable of using the method of FIG. 3.

### DETAILED DESCRIPTION

Embodiments of the invention comprise a method and system for managing and storing data in memories. While the invention is intended primarily for use with a portable handheld system that can accommodate various consumer applications such as MP3 players, digital recorders and other portable electronic devices which allow for capturing, creating, storing, manipulating or transferring digital music, sounds, images, movies or other encoded data such portable systems being particularly subject to shock mechanical shock, embodiments of the invention are also applicable to larger and more stationary systems. In a particular handheld portable system, a redundant array of independent memories is available for a controller module and one or more consumer applications. During writing of application data to one memory, the other memory or memories are parked to prevent loss of data due to shock, vibration or other physical forces to which they may be subjected. As used herein, “parking” refers to positioning the read head of the disk drive to a position away from the data bearing portion of the disk. When writing to the first memory has been completed, it too is parked to prevent such damage so that the memory will be available for redundant data transfer.

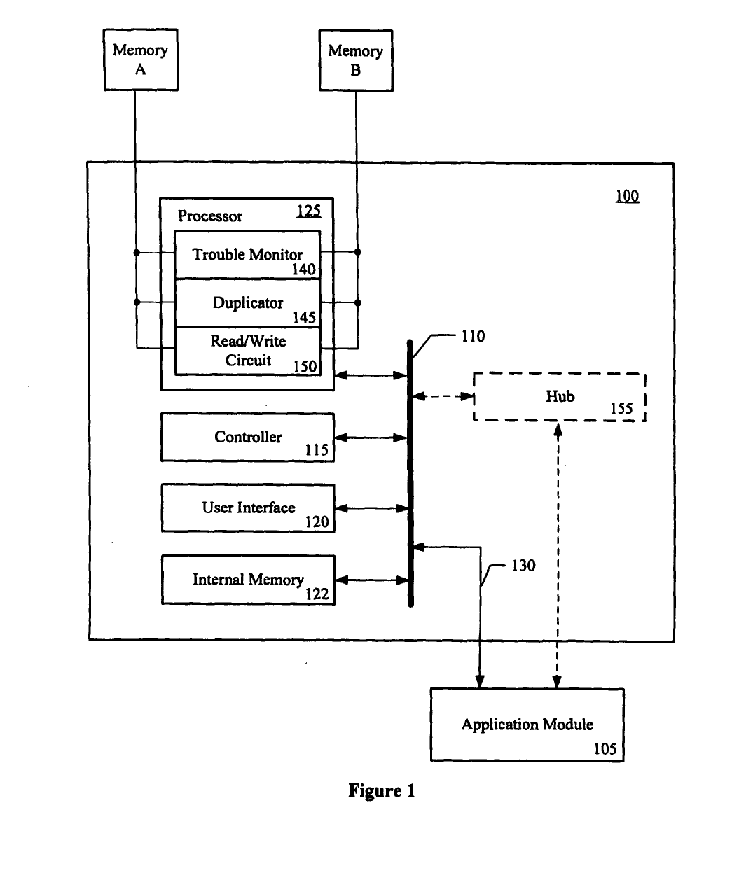

FIG. 1 illustrates an implementation of a controller module 100 to control a pair of such memories. The controller module 100, which can be referred to as a Compact Unlimited Library Controller, is shown in communication with memories A and B and an application module 105. The controller module 100 includes a bus 110 in communication with a controller 115, a user interface 120, an internal memory 122, and a processor 125. These components manage and control the flow of application data between the controller module 100 and the application module 105 along bus 110 and a data path 130 to the application module 105, and the data flow between the controller module 110 and memories A and B. The processor 125 and controller 115 may be integrated into a single device. Similarly, internal memory 122 may be integrated onto a single chip with either the processor 125 or controller 115, or both. Also, although the controller module 100 and application module 105 are described as discreet “modules,” the system may not have discreet modules but may be integrated into a single component.

The processor 125 provides several functions and comprises a trouble monitor 140, a duplicator 145 and a read/write circuit 150. The trouble monitor 140 detects whether memories connected to processor 125 are operating correctly, and notifies the user of problems through the user interface 120. Duplicator 145 enables direct duplication of application data between memory A and memory B when a memory is replaced, without the use of other external devices such as a PC. The duplicator 145 also communicates through the bus 110 with the user interface 120 to provide information to a user regarding duplication efforts. The read/write circuit 150 communicates with external applications such as the application module 105, and governs the read/write of data to the master and slave memories memory A or memory B during normal operation. The elements 140, 145, 150 may be implemented in firmware, or by using a software controlled general purpose DSP (digital signal processor). The bus 110 is illustrated with electrically conductive paths between the processor 125, controller 115, user interface 120, and internal memory 122. An optical bus may also be used, as well as any manner of signal conduit, medium, or signaling method. Details of the implementation of such functions are well known in the art.

Memories A and B are shown in direct communication with the processor 125. They could also communicate with the processor 125 through the bus 110, and utilize a data protocol with an addressing scheme that is managed by the processor 125 and controller 115 to distinguish between the two memories.

In an alternative embodiment, a hub 155 is provided in the controller module 100 to enable use of the controller module 100 with additional applications. If the bus 110 communicates with an application module 105 via the hub 155, the data path 130 would be deleted. A wireless scheme utilizing Bluetooth™ wireless technology or some other wireless scheme could also be provided for the data path between the controller module 100, memories A and B and application 105.

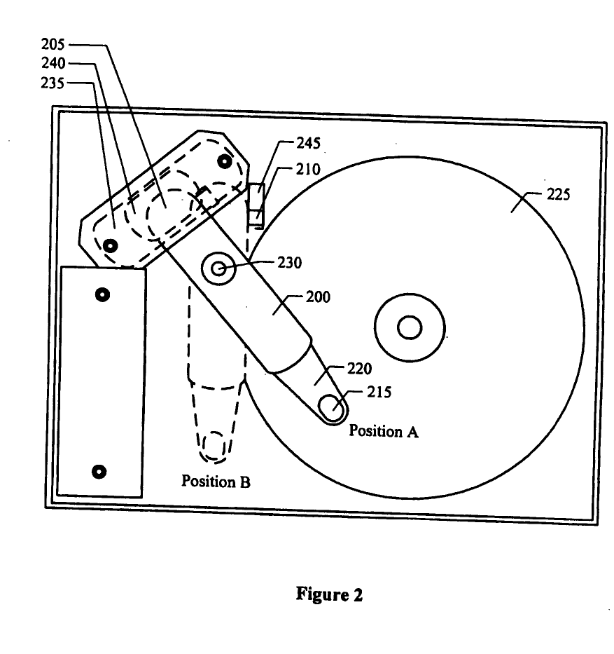

FIG. 2 illustrates an exemplary disk drive that can be used for memory A or B. The disk drive has an actuator motor arm 200 with a proximal end 205, a parking lever 210 extending from the proximal end 205 and a read head 215 on a distal end 220. The actuator motor arm 200 is held above hard disk plate 225 and pivots about a spindle 230, utilizing a driving force between a permanent magnet 235 and a coil 240 which acts on the proximal end 205. The actuator motor arm 200 rotates from an in-use position such as Position A, at which the reading head 215 is aligned with the disk plate 225, to a parked position such as Position B, with the read head 215 offset from the disk plate 225. A parking mechanism 245 captures the parking lever 210 when the motor arm is in the parked position. The illustrated parking mechanism is a spring-loaded latch arm.

Actuator motor arm 200 may be parked towards the center of hard disk plate 225 and away from the data portion of the disk. The parking lever 210 may be suitably modified for use in this alternate position. The parking mechanism used is not critical, and any of a variety of well known parking mechanisms may be used. For example, a weak spring may be used to pull the read head 215 aside when the coil 240 is de-energized, or a high-efficiency retract circuit may be used to apply current from the spindle back-EMF to the actuator motor arm 200. This action moves the actuator to the parked position while the disks are spinning down. In each of these embodiments, the hard disk plate 225 may continue to rotate when the drive is parked. By moving the read head 215 to a position removed from the data carrying portion of hard disk plate 225 during park, damage to the data on the hard disk plate 225 can be voided should the read head 215 accidentally strike the hard disk plate 225. Also, although the actuator motor arm 235 is described as moving between a permanent magnet 240 and coil 240, the actuator motor arm 235 may be driven by other mechanisms, such as coils or electromagnets.

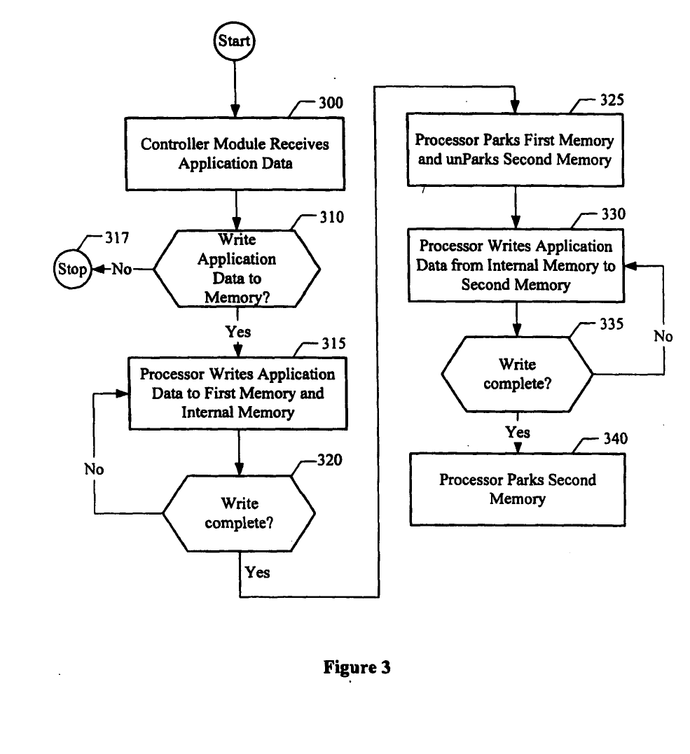

FIG. 3 describes an embodiment of the invention for saving application data to memory without risk of data loss due to the read head 215 contacting the disk plate 225. The controller module 100 receives the application data from the application module (or modules) 165 (block 300), under the control of the read/write circuit 150 in processor 125. If the application data is to be saved in a memory (block 310), then the processor writes the application data to the internal memory 122 and to a first memory such as memory A (block 315). If a save is not desired, the save process stops at this point (block 317). When the processor receives an indication that the write to the first memory is complete (block 320), the processor 125 sends a signal to park the first memory, and subsequently sends a signal to unpark a second memory, such as memory B (block 325). The processor 125 then writes the application data from the internal memory 122 to the second memory (block 330) and, when the write is complete (block 335), sends a signal to park the second memory (block 340). The application data previously saved to the first memory (block 315) is thus guarded against shock or physical vibration while the application data is being replicated to the second memory. If memory B is subjected to sufficient force to damage it during a write, the application data in the first memory provides redundancy for the user.

In one example, the application data from application module 105 is parsed into application data segments, in accordance with the structure of internal memory 122, for writing to memories A and B. In this manner, each successive segment of the application data will be written first to memory A and then to memory B, until the entire application file is saved in both memories. During each respective write, only the memory being written to is unparked. In this manner, memories A and B provide a data redundancy that is resistant to shock and physical vibration. Also, although the processor receives an indication that the write is complete prior to locking the memory (block 320), the processor may send application data to memory in regular predetermined amounts followed by a park command, thus obviating the need for a write complete indication from the memory prior to parking the first memory and unparking the second (block 325). Also, rather than a memory receiving a park command, the memory may be manufactured to park automatically at the conclusion of a particular write.

Although “parking” has been described in relation to a disk drive, the same concept may be applied to any data storage device that is at risk of data loss from mechanical vibration or shock. For example, in a data storage system that depends on movement of an armature to impart physical or electrical changes to a data storage medium to store data, the armature may be alternately parked between writing to first and second memory devices. For memories in which a moving mirror directs radiation to the surface of a data storage medium, the mirror will write application data and park. The second memory is then “unparked” to receive the application data previously written to the first memory. The second memory then parks when its receipt of application data has been completed. Alternatively, the memories may be of different types. For example, a disk drive may be implemented in parallel with a semiconductor memory device. The application data would be written to the disk drive, the disk drive parked, and then the application data then written to the semiconductor memory device.

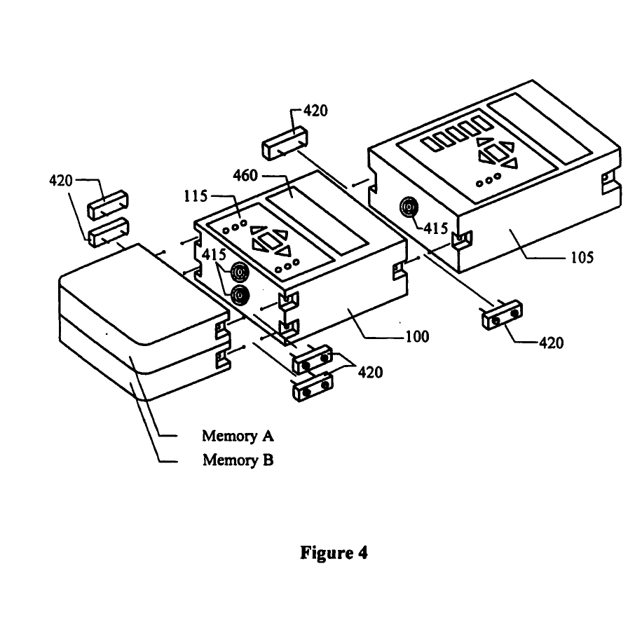

While the invention is applicable to multiple memory systems in general, exemplary embodiments of the invention are particularly useful for portable handheld modular consumer electronic products such as those shown in FIGS. 4, 5 and 6. Such a modular system allows a controller and multiple memories to be packaged together by the consumer with whichever application modules the consumer desires. In FIG. 4, a controller module 100 is shown aligned for electrical and mechanical connection with an application module 105 through an electrical connector 15 in the application module 105 and a complementary, opposed connector (not shown) in the controller module 100, and mechanical connectors 420. The controller module 100 manages application data sent from the application module 105 to the memories A and B.

The application module 105 may be any portable electronic consumer application such as a video/still image player or reviewer, a PDA, a digital still or video camera, or an MP3 player. The application module 105 can also be connected in turn to a second application module (not shown) through electrical and mechanical connectors similar to electrical connector 415 and mechanical connectors 420. In such a case, the controller module 100 may distinguish between the different application modules by a data addressing scheme.

The symmetrical electrical connector 415 allows the application module 105 to be connected to the system in numerous different orientations making assembly easier for an untrained consumer.. The module can be detached from the system and replaced with a different application, or additional application modules can be connected to the first one, again without regard to their exact orientation. Mechanical connectors 420 hold the modules together once they have been positioned. The electrical connector 415 is symmetric about an axis running through the application module 105 and controller module 100 to allow for different rotational orientations between modules without loss of electrical contact after the mechanical connectors 420 are engaged or re-engaged. The illustrated electrical connector 415 has four circular electrical contacts, providing two data paths and two power paths between the devices (100, 105). The connectors for adjacent modules are unisex in nature and spring-biased to extend slightly outward from their respective modules, providing a secure electrical contact when brought in contact with each other and held in place with mechanical connectors 420.

Alternatively, the electrical connectors 415 are not symmetric about their axes, but may allow for reorientation while maintaining suitable electrical connection after the mechanical connectors 420 are reengaged. The electrical connectors 415 may be provided with male and female clamps or the like so that they function as mechanical as well as electrical connectors, thus eliminating the need for separate mechanical connectors 420. The electrical connectors may have more or fewer than the four contacts illustrated, depending upon the data and power requirements of the intended modules.

Memories A and B are shown aligned for electrical connection with the controller module 100 through a pair of electrical connectors 415 in the controller module, and a complementary pair of electrical connectors (not shown) in the memories, one for each memory. Each memory can be individually replaced if it goes bad, and a new memory installed with either the same or a 180° rotated orientation with respect to the controller moduel 100. The electrical connectors 415 between the controller and memory modules have the same design as corresponding to the connector lines between the processor 125 and memories A and B, the electrical connectors 415 between the controller and application modules, which correspond to connector line 130 in FIG. 1.

The physical shapes of memories A and B, the controller module 100 and the application module 105 are illustrated as rectangular for convenience, but other shapes may be used as desired. The modules can be assembled in various geometric configurations. For example, and not by way of limitation, they may be stacked end-to-end along a linear axis, in an L or T shape, or in a square-like or some other commercially desirable shape. In such cases, the electrical connectors 415 and mechanical connectors 420, between the modules may need to be moved to other locations on their respective modules.

Controller module 100 is shown having a keypad user interface 120, and a display 460. The user interface 120 may alternately be a microphone for speech recognition, a pressure sensitive touch screen using thin film transistors (TFT), or some other device or combination of devices for inputting information (not shown). The display 460 provides information to the user regarding application data transfer, memory device activities, and data retrieval. Alternatively, the display 460 may be incorporated into the user interface 120 such as by utilizing a TFT screen, allowing for both display and receipt of information.

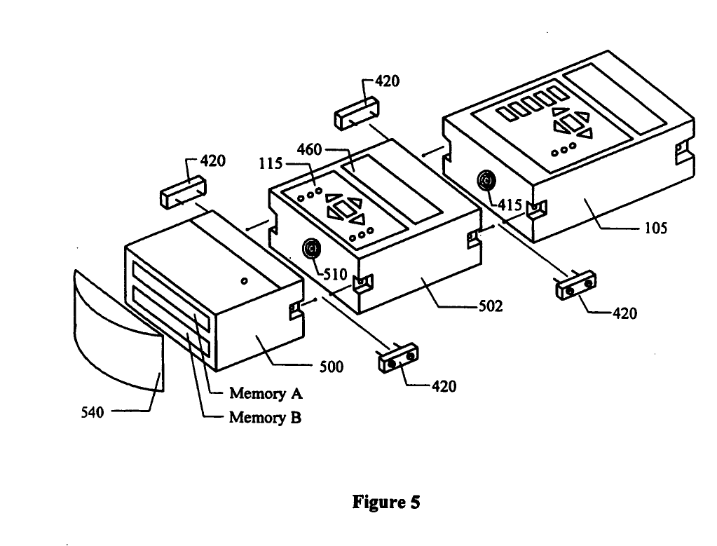

The embodiments shown in FIGS. 1-3 may also be implemented as shown in FIG. 5, in which memories A and B are seated in a common memory storage module 500 that is designed to receive standardized form factor memories. In this example, memories A and B are each microdisk drives inserted into the memory module 500. Examples of microdisk drives include the 340 MB™ and 170 MB™ products sold by IBM® Corporation. Other currently available small form factor memories that may be used in memory module 500 include a SmartMedia Card, Memory Stick, Multimedia Card or Miniature Card. Although memories A and B are inserted in one end of the memory module 500, they may be placed in different locations in the module. For example, the memory slots may be moved to the top or bottom, rather than the end, of the module. A cover 540 is shown covering the slots for memories A and B to protect them from damage. The cover is held in place by hinges, screws, a snap tab or other convenient mechanical arrangement, and may be provided as separate disengageable covers for each of the memories. Only a single electrical connector 510 is provided on the memory module 500 for mating with a similar single connector 510 on the opposed face of the controller module 502. In this embodiment both memories A and B are connected to a common electrical connector 510, with the controller module 502 distinguishing between them by assigning them different digital identification codes.

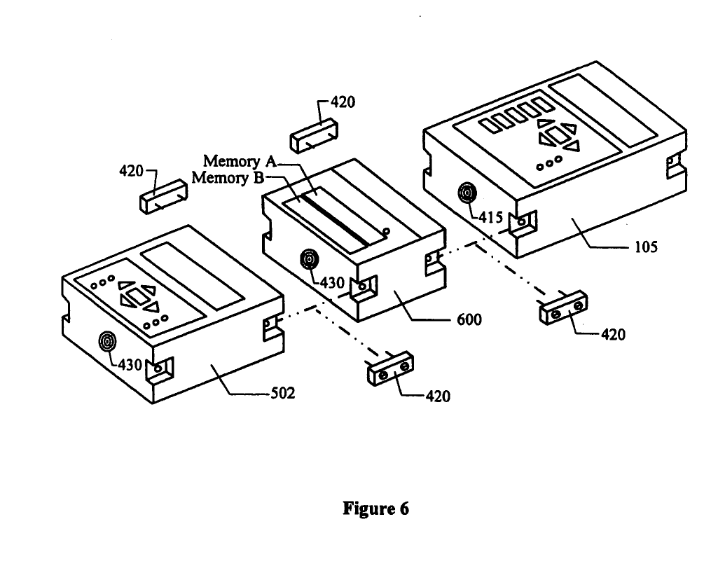

Referring to FIG. 6, the controller module 502, application module 105 and a memory module 600 are shown in a different configuration with respect to each other. Namely, the memory module 600 is now connected between the application module 105 and controller module 502 with its memories loaded from the top rather than parallel to the system axis as in FIG. 5. The memory module 600 in this embodiment has electrical connectors 415 on its opposite sides, along the system axis, for this purpose.

While various embodiments of the application have been described, it will be apparent to those of ordinary skill in the art that many more embodiments and implementations are possible that are within the scope of this invention.

1. A method of storing application data in a redundant array of independent memories, comprising:
entering the application data in a first memory;
parking the first memory when the first memory has received the application data;
unparking a second memory;
entering the application data in the second memory; and
parking the second memory when the second memory has received the application data, thereby reducing the likelihood of losing application data due to physical impacts to the memories.

2. The method of claim 1, wherein the first memory is initially parked, and then unparked prior to receiving the application data.

3. The method of claim 1, wherein each of said memories comprises a respective disk drive having a hard disk plate, said respective disk drive capable of being parked by moving an actuator motor control arm on said disk drive to a location removed from a data portion of said hard disk plate, and securing said actuator motor control arm in said removed location to restrain said control arm from contacting said hard disk plate when the memory is subjected to shock.

4. The method of claim 1, wherein said application data is entered into to said second memory by:
entering the application data to an internal controller memory; and
retrieving the application data from said internal controller memory to enter the application memory in the second memory.

5. The method of claim 1, wherein the application data is sent from a processor that comprises a common bus to the first memory along a data path that is removed from said bus.

6. A method of saving application data in a redundant array of independent memories, comprising:
receiving the application data in a controller module;
unparking a first memory;
writing the application data from the controller module to the first memory;
parking the first memory;
unparking a second memory;
writing the application data from the controller module to the second memory; and
parking the second memory, thereby reducing the likelihood of irretrievably losing application data due to impacts damage to either memory.

7. The method of claim 6, wherein the controller module receives said application data from an application module.

8. A master-slave data management system, comprising:
a processor;
a bus in communication with the processor; and
first and second data paths removed from the bus and providing the processor with communication with first and second memories, respectively;
wherein the processor is programmed to avoid writing application data to the first memory unless the second memory is parked and the first memory is unparked.

9. The system of claim 8, wherein the processor comprises a read/write portion and writes to the first memory through said read/write portion.

10. The system of claim 8, wherein the processor is programmed to avoid writing application data to the second memory unless the first memory is parked and the second memory is unparked.

11. A master-slave data management system, comprising:
a processor; and
first and second memories in communication with the processor;
wherein the processor is programmed to send application data to the first memory, park the first memory when it has received the application data, unpark the second memory, and send the application data to the second memory, and park the second memory when it has received the application data, thereby reducing the likelihood of losing application data due to impacts to a memory.

12. The system of claim 11, further comprising:
a bus in communication with the processor; and
first and second data paths separate from the bus and providing the processor with communication with said first and second memories, respectively.

13. The system of claim 11, wherein the processor includes a read/write portion and writes to the first and second memories through said read/write portion.

14. A method of writing data to a plurality of redundant memories, comprising:
writing the data in succession to each of said memories; and
parking each memory upon completion of each memory's data write and prior to writing the data to the next memory.

15. The method of claim 14, wherein each memory is unparked prior to writing data to each memory.

16. The method of claim 14, wherein parking comprises:
sending a park command from a controller to each memory upon completion of its data write and prior to writing the data to the next memory.

17. The method of claim 16, wherein said park commands are generated internally within said controller.
